(19) United States
(12) Patent Application Publication
(10) Pub. No.: US 2023/0362656 A1
(43) Pub. Date: Nov. 9, 2023

(54) SYSTEMS AND METHODS FOR THE GENERATION OF EVENT OPPORTUNITIES FOR DISPLAY ON DEVICES HAVING DIFFERING FORM FACTORS

(71) Applicant: SB22, Inc., Dallas, TX (US)

(72) Inventor: Vladimir Jovanovic, Belgrade (RS)

(21) Appl. No.: 18/314,361

(22) Filed: May 9, 2023

Related U.S. Application Data
(60) Provisional application No. 63/364,386, filed on May 9, 2022.

(51) Int. Cl. H04W 12/33; H04W 12/104; H04W 12/06

(52) U.S. Cl. CPC H04W 12/33; H04W 12/104; H04W 12/06

(57) ABSTRACT

Aspects of the present disclosure relate to an event application formatted for a wearable device such as a smartwatch. The wearable device user interface organizes event information so that it may be viewed and interacted with via the touchscreen and controls of the wearable device. The user may provide input to transition between event categories, events, and interactive elements associated with the event directly on their wearable device. The wearable device format provides increased access for the user wherever they are without requiring them to carry around a bulky external device. Further, the wearable device format provides access directly on the user's wrist making it easier for the user to perform other tasks and still access the event application. Ultimately, the wearable device format simplifies the user's ability to interact with the event application while maintaining application functionality on a smaller device.

### CROSS-REFERENCE TO RELATED APPLICATION

This application claims priority to U.S. Provisional Application No. 63/364,386, titled “SYSTEMS AND METHODS FOR THE GENERATION OF GAMING OPPORTUNITIES FOR DISPLAY ON DEVICES HAVING DIFFERING FORM FACTORS” filed on May 9, 2022, the entire disclosure of which is hereby incorporated by reference in its entirety.

### BACKGROUND

As the event industry evolves into the online marketplace, the number, and types of events available to the public via streaming event applications has grown considerably. However, these applications are currently limited to being accessed on mobile devices, tablets, and other larger computing devices. These devices can be large and difficult to transport away from a user's home or place of business. As a result, the user may be restricted in their ability to access the application and select interactive elements associated with an event in real-time.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Aspects of the present disclosure relate to a user interface and accompanying controls for an event application on a wearable device such as a smartwatch. The wearable device user interface organizes event information so that it may be viewed and interacted with via the touchscreen and controls of the wearable device. The user may provide input to transition between one or more events and select interactive elements associated with the event directly on their wearable device. The event offers may be condensed to facilitate the wearable device form factors and provide enhanced utility to the user. In some examples, the wearable device may provide the event application on its own, while in other examples the wearable device may display the application but communicate with the system via an intermediate device like a mobile device. The wearable device format provides increased access for the user wherever they are without requiring them to carry around a bulky external device. Further, the wearable device format provides access directly on the user's wrist making it easier for the user to perform other tasks and still access the event application. Ultimately, the wearable device format simplifies the user's ability to interact with the event application while maintaining application functionality on a smaller device.

This Summary is provided to introduce a selection of concepts in a simplified form, which is further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the following description and, in part, will be apparent from the description, or may be learned by practice of the disclosure.

### BRIEF DESCRIPTIONS OF THE DRAWINGS

Non-limiting and non-exhaustive examples are described with reference to the following figures.

FIG. 1 depicts an exemplary event application system, according to aspects described herein.

FIG. 2 depicts an exemplary user interface for a wearable device, according to aspects described herein.

FIG. 3 depicts another exemplary user interface for a wearable device, according to aspects described herein.

FIG. 4 depicts a further exemplary user interface for a wearable device, according to aspects described herein.

FIG. 5 depicts a still further exemplary user interface for a wearable device, according to aspects described herein.

FIG. 6 depicts an exemplary user interface for confirming a selection on a wearable device, according to aspects described herein.

FIG. 7 depicts an exemplary user interface with a confirming notification for a wearable device, according to aspects described herein.

FIG. 8 is a block diagram illustrating a method for placing a bet via an event application on a wearable device, according to aspects described herein.

FIG. 9 is a block diagram illustrating a method for placing a bet from a wearable device, according to aspects described herein.

FIG. 10 is a block diagram illustrating a method for authorizing a user and geo-locating a device by an intermediate device, according to aspects described herein.

FIG. 11 is a block diagram illustrating a method for receiving a bet at an event server, according to aspects described herein.

FIG. 12 illustrates a simplified block diagram of a device with which aspects of the present disclosure may be practiced, according to aspects described herein.

### DETAILED DESCRIPTION

Various aspects of the disclosure are described more fully below with reference to the accompanying drawings, which from a part hereof, and which show specific example aspects. However, different aspects of the disclosure may be implemented in many ways and should not be construed as limited to the aspects set forth herein; rather, these aspects are provided so that this disclosure will be thorough and complete and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

The latest trends in the events industry are expanding the available event offerings via online event applications making it possible to participate in the immersive event experience from distant locations. An issue is that the event applications are presently limited to use via mobile device, tablet, or computing device. This hardware limitation negatively impacts both the users and application developers. From the user perspective, the larger hardware requirements limit the user's ability to easily interact with the application wherever they are. Thus, if a user intends to interact with the application they may be tied to a bulky device, that is not easy to carry around and utilize during an active lifestyle. As a result, the application developer may lose customer engagement opportunities which in turn reduces their ability to profit from the application.

To address these issues, aspects of the present disclosure relate to systems and methods for providing an event application on a wearable device, such as a smart watch. The event application may be formatted to present event information and interactive elements associated with the event in a wearable format. In some examples, the wearable device may host the event application directly including applicable security authorization features and location services for the application. In other examples an intermediate device such as a mobile device, tablet, or computing device may be utilized for security authorization and location services. The event application may provide access to a variety of event categories relating to music and concerts, sports games, theater, and/or other events. When a user selects an event category, specific events relating to that category may be displayed for the user to view and interact with via input to the wearable device (e.g., via the touch screen of the device and/or device controls). Selecting an event may bring up additional interactive elements associated with the event including items for purchase, betting options, and/or other interactive elements.

The event application in a wearable format provides several benefits. One, is that the user has direct access to the event application directly from their wrist, with no need to pull out a separate device from their pocket even. Further, the enhanced accessibility means that there is no need for the user to carry an additional device or remain in a single location with a computing device to access the application. Thus, the user may be completely mobile and so long as there is a network available, the user may access the event application. Importantly, while the format of the event application may differ from that of other devices, the functionality is not diminished in the wearable format. From the application developer's perspective, the increased accessibility equates to greater user engagement with the event application which increases revenue and application success. Ultimately, the wearable format provides enhanced accessibility with consistent functionality all from the user's wrist.

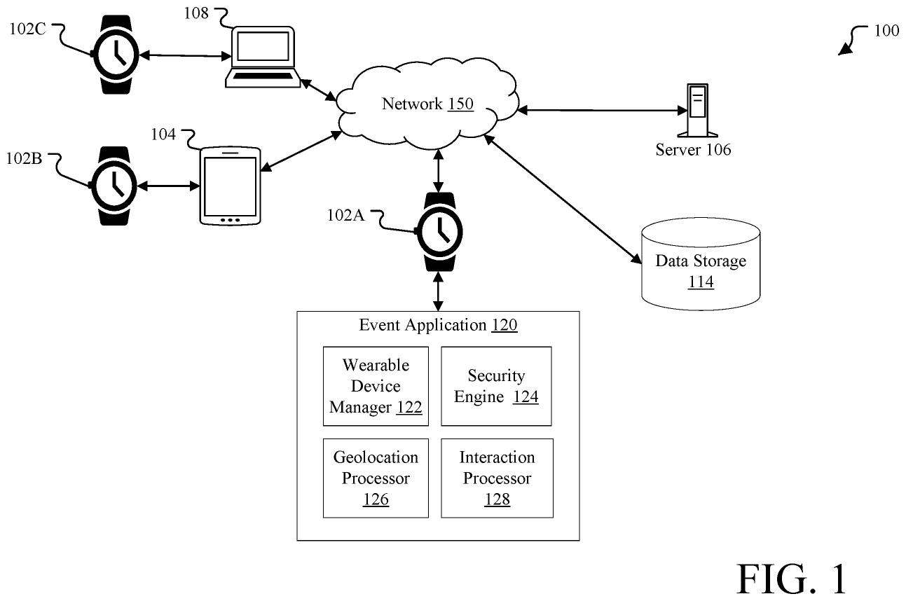

FIG. 1 depicts an exemplary event application system, according to aspects described herein. System 100 includes wearable devices 102A-C, mobile device 104, computing device 108, server 106, data storage 114, and network 150. Although the exemplary wearable devices 102A-C are depicted as smartwatches, one of skill in the art will appreciate that other types of wearable devices may be employed by system 100 without departing from the scope of this disclosure. As shown in system 100, the wearable devices, such as wearable device 102A, may connect to the network 150 directly via a Wi-Fi connection or a cellular data connection or through an intermediate device. For example, smartwatch 102B connects to the network 150 via mobile device 104, while smartwatch 102C connects to network 150 via computing device 108. Network 150 may be any type of network, such as, for example, a LAN, a WAN, a near-field communications network, a cellular broadband network, point-to-point network, a Wi-Fi network, the Internet, etc. and may include one or more of wired, wireless, and/or optical portions. For ease of discussion the wearable device 102A-C will be referred to as a wearable device 102 unless greater clarity is helpful to the discussion herein.

The wearable device 102 may include an event application 120 including wearable device manager 122, security engine 124, geolocation processor 126, and interaction processor 128. In examples, a user may access the event application 120 and be presented with one or more interfaces for viewing events and interactive elements associated with the event in a wearable format. The wearable device manager 122 may be utilized to coordinate the events, event categories, and interactive elements associated with an event that are displayed to the user. In this context an event is the occurrence of some thing that the user may want to participate in via the one or more interactive elements accessible via the event application 120. Thus, an event may be a plurality of things from traditional events like a sporting event (e.g., football game, basketball game, golf, hockey, racing, etc.), a music concert, theater performance, movie, TV show, etc. to a video game, live-streamed gaming competition, conferences, etc.

Event categories are utilized by the wearable device manager 122 to organize the plurality of events that may be available so that events can be presented to a user in an ordered way. For example, one event category could be sports and include a list of sports leagues, upcoming games, and even non-game sports related events (e.g., rookie draft, combine activities, sports related TV shows and documentaries, etc.). Another event category may be music and include upcoming concerts, different musical genres, etc. A gaming event category could include specific video games with options to view other players, live video streaming options, competitive game competitions, etc.

The interaction processor 128, may track user input to the wearable device 102 and direct one or more workflows based on the received input. Each event and event category may have one or more interactive elements associated with it which the user can select via gesture input on the touchscreen of the wearable device 102 and/or via physical input on the control features of the wearable device (e.g., rotating a rotating element, pressing a button, etc.). An interactive element is any selectable aspect related to the event which is offered to the user. Examples of interactive elements may be things commonly associated with an event. For example, if the event is a college football game interactive elements may include betting opportunities, option to buy ticket, viewing options for the game, and merchandise (e.g., jerseys, team gear, branded footballs, etc.). However, the interactive elements are not limited and could include things like an option to purchase music associated with the game (e.g., college fight songs, a recording of the national anthem or halftime show, etc.) as well as NFTs of in-game highlights, among others.

In some examples, the workflow indicated by the user input may involve placing a bet for an event. In such an instance, the security engine 124 will authenticate the user via a username and password combination and/or a form of biometric identification associated with the account and stored in data storage 114. When the user is authenticated, the geolocation processor 126 may determine if the user is in a permitted location for betting based on the user's current location. A permitted location is a location where placing a bet is permitted by the appropriate regulations for the location. In this case, the geolocation processor 126 will request the current location of a location enabled device based on the configuration that the user is utilizing to access the event application 120. In some instances, the location enabled device may be the wearable device 102A itself. In other instances, the intermediate devices mobile device 104 and computing device 108 may be location enabled and receive the request.

If the current location is a permitted location, then the interaction processor 128 may place the bet for the user. If the current location is not a permitted location, then the geolocation processor 126 will inform the interaction processor 128 to deny the betting request until the current location may be confirmed. A current location may not be a permitted location for a variety of reasons including because the known current location is not a permitted location, the current location is an unknown location meaning the geolocation processor 126 did not receive a response and/or could not verify the response from the location enabled device, and/or the current location is a boundary location meaning the current location is close enough to a regulatory boundary that the geolocation processor 126 cannot determine if the current location is within the regulatory area that permits betting or not. In some example, the current location may be an unknown location because the wearable device 102B or 102C are too far away from the mobile device 104 or computing device 108 respectively. In such an instance, the user may be prompted to move the wearable device 102B or 102C closer to the associated intermediate device and reattempt the location request.

Server 106 is operable to connect to any number of devices (e.g., wearable devices 102A-C, mobile device 104, and computing device 108) and to provide information about available events and receive requests to interact with interactive elements from such devices. Server 106 is further operable to connect to data storage 114 which stores information about current, future, or past events and event categories, information utilized by the event application 120 relating to user accounts, information about various interactive elements, and the like. Data storage 114 may be updated in real-time to update interactive elements (e.g., modify ticket and/or seat availability for an event, update odds for existing bets, include new bets for an event (e.g., a sporting event, an e-sport event, etc.) and/or other types of interactive elements as an event progresses. Example interactive elements may be live bets such as whether a player makes his next free throw, whether the next play results in a first down, whether a goal is scored in the next 5 minutes, etc. Server 106 accesses the data storage 114 to retrieve information about an event and/or available interactive elements in response to a request from a device (e.g., wearable devices 102A-C, mobile device 104, and computing device 108). Exemplary devices are operable to receive the event category, event, and/or interactive element information from the server 106 in response to a request from the wearable device 102 and display the received event category, event, and/or interactive element information in a format suitable for the wearable device 102.

Although specific types of wearable devices have been depicted as part of system 100, one of skill in the art will appreciate that different types of wearable devices may be employed by the system without departing from the scope of this disclosure. Further, while specific types of user interfaces (e.g., displays) and user interface controls (e.g., gesture control, crown control, etc.) have been described, one of skill in the art will appreciate that other types of controls or user interfaces may be employed by the system 100 without departing from the scope of this disclosure. For example, an audio and speech interface may be employed and/or a haptic feedback interface may be employed in addition to, or in place of, the user interface flow depicted in FIG. 1 without departing from the scope of this disclosure.

Wearable devices 102A-C, mobile device 104, and computing device 108 may be configured to execute one or more applications, such as event application 120, and/or services and/or manage hardware resources (e.g., processors, memory, etc.), which may be utilized by users of the devices. The wearable devices 102A-C, mobile device 104, and computing device 108 can send and receive content data as input or output which may be, for example from a microphone, an image capture device (e.g., a camera), location services including a global positioning system (GPS), etc., that transmits content data, a computer-executed program that generates content data, and/or memory with data stored therein corresponding to content data. The content data may include visual content data, audio content data (e.g., speech or ambient noise), a viewer-input, such as a voice query, text query, etc., an image, an action performed by a viewer and/or a device, a computer command, a programmatic evaluation gaze content data, calendar entries, emails, document data (e.g., a virtual document), weather data, news data, blog data, encyclopedia data and/or other types of private and/or public data that may be recognized by those of ordinary skill in the art. In some examples, the content data may include text, source code, commands, skills, or programmatic evaluations.

Wearable devices 102A-C, mobile device 104, and computing device 108 may each include at least one processor, such as interaction processor 128, that executes software and/or firmware stored in memory. The software/firmware code contains instructions that, when executed by the processor causes control logic to perform the functions described herein. The term “logic” or “control logic” as used herein may include software and/or firmware executing on one or more programmable processors, application-specific integrated circuits (ASICs), field-programmable gate arrays (FPGAs), digital signal processors (DSPs), hardwired logic, or combinations thereof. Therefore, in accordance with the examples, various logic may be implemented in any appropriate fashion and would remain in accordance with the examples herein disclosed.

In accordance with some aspects, data storage 114 may be a network server, cloud server, network attached storage (“NAS”) device, or another suitable computing device. Data storage 114 may include one or more of any types of storage mechanism or memory, including a magnetic disc (e.g., in a hard disk drive), an optical disc (e.g., in an optical disk drive), a magnetic tape (e.g., in a tape drive), a memory device such as a random-access memory (RAM) device, a read-only memory (ROM) device, etc., and/or any other suitable type of storage medium. Although only one instance of the data storage 114 is shown in FIG. 1, the system 100 may include two, three, or more similar instances of the data storage 114. Moreover, the network 150 may provide access to other data stores similar to data storage 114 that are located outside of the system 100, in some examples.

In some examples, the network 150 can be any suitable communication network or combination of communication networks. For example, network 150 can include a Wi-Fi network (which can include one or more wireless routers, one or more switches, etc.), a peer-to-peer network (e.g., a Bluetooth network), a cellular network (e.g., a 3G network, a 4G network, a 5G network, etc., complying with any suitable standard), a wired network, etc. In some examples, network 150 can be a local area network (LAN), a wide area network (WAN), a public network (e.g., the Internet), a private or semi-private network (e.g., a corporate or university intranet), any other suitable type of network, or any suitable combination of networks. Communication links (arrows) shown in FIG. 1 can each be any suitable communications link or combination of communication links, such as wired links, fiber optics links, Wi-Fi links, Bluetooth links, cellular links, etc.

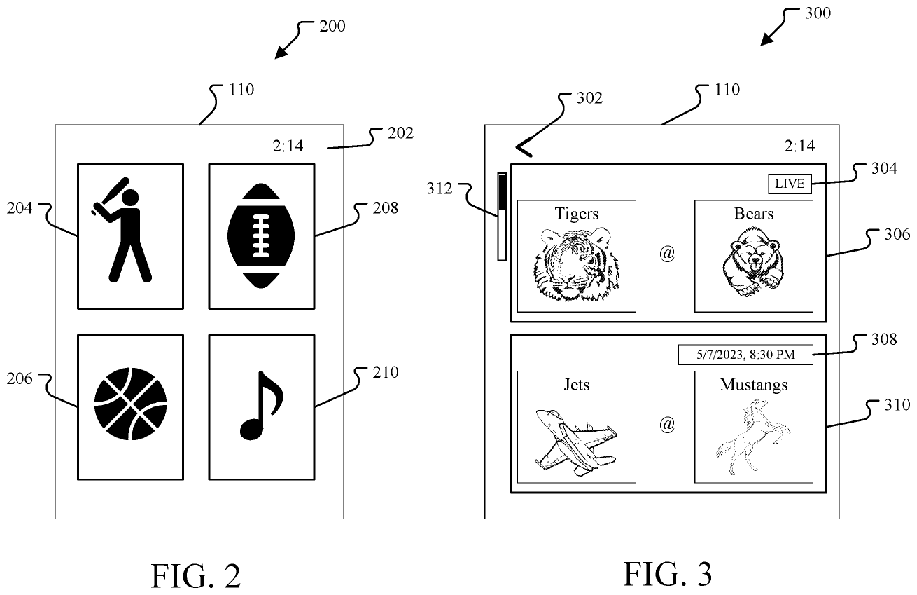

FIG. 2 depicts an exemplary user interface for a wearable device, according to aspects described herein. As displayed the event application may be accessed by the user and a main menu screen 202 on user interface 110 may be initially displayed on the wearable device. The user interface may have one or more event categories 204-210 presented to the user to select from. The event categories may be for a variety of events such as baseball 204, football 208, and/or music 210 among others. The user may provide touch input to select one of the categories and transition the user interface 110 to a new screen. For example, the user may select the basketball 206 event category and transition to the user interface 110 shown in FIG. 3.

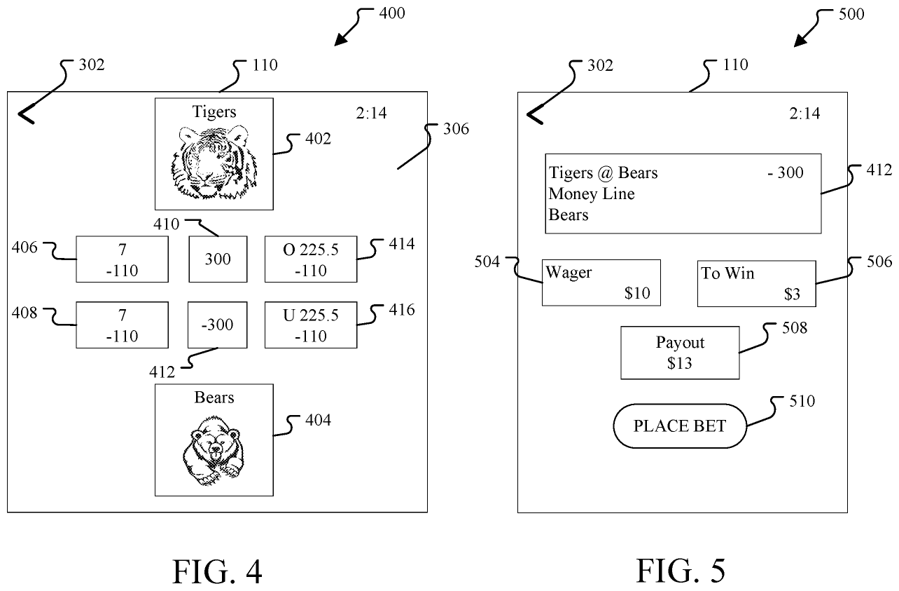

FIG. 3 depicts another exemplary user interface for a wearable device, according to aspects described herein. As displayed one or more events for the selected event category are presented on the user interface 110. In this example, two events 306 and 310 relating to basketball games are displayed. The events may include information associated with the event as well as interactive elements for the user to select from. For example, event 306 includes images of the two teams competing in the basketball game as well as indicator 304 informing the user that the game is currently “live.” If the event is not live, as in event 310, there may be an indicator 308 informing the user when the event is scheduled to occur. A slider option 312 may be presented on user interface 110 to indicate to the user that there are additional event options available to scroll through. The user may provide input to select one of the events, such as event 306, which would transition the event to the next screen. It should be appreciated that the user may also go back to a screen by selecting back arrow 302. In the present example, the user may provide a tapping gesture on event 306 to select it and transition the user interface to FIG. 4.

FIG. 4 depicts a further exemplary user interface for a wearable device, according to aspects described herein. The user interface 110 now displays the event 306 with a variety of betting options 406 to 416 available as interactive elements for user selection. The team icons 402 and 404 may be displayed above and below the interactive elements to indicate the event 306 and/or to indicate which betting options are applicable to which team. While betting options are displayed for a sporting event, it should be appreciated that the event could be a plurality of event types, such as a concert, with interactive elements associated with the concert like ticket purchases and/or apparel available for purchase. In this case, the user may select an interactive element 412 and transition the user interface 110 to FIG. 5 where more information about the betting option is presented.

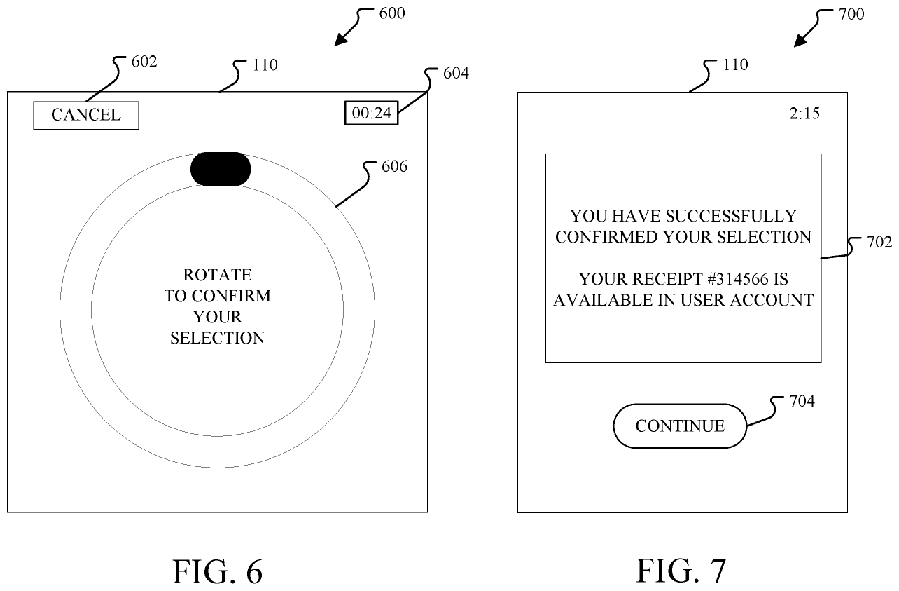

FIG. 5 depicts a still further exemplary user interface for a wearable device, according to aspects described herein. The user interface 110 now displays more information relating to the bet 412 selected in FIG. 4. There may be an indication of the event, Tigers @ Bears, the type of bet, money line, the team for the bet, Bears, and the odds, −320, among a plurality of other relevant information based on the selected bet and/or interactive element. There may also be a wager field 504 where the user may input the bet amount and an information field 506 where they user may see their expected winnings with an ultimate payout field 508 with total payout for a winning bet. In some instances, the user may enter one or more values into any of the fields 504, 506, or 508 and based on the bet selected and odds indicated the interaction processor may automatically determine the appropriate amounts for the other fields. In this way the user may utilize the wearable device as a tool to determine a desirable bet. Once the user has input has input their wager, they may select to place the bet via button 510, and transition to FIG. 6.

FIG. 6 depicts an exemplary user interface for confirming a selection on a wearable device, according to aspects described herein. To confirm a selection on the wearable device the system may utilize the rotating element on the side of the wearable device. The user may be presented with the exemplary user interface 110 with the message to “rotate to confirm your selection” and the progress indicator 606. The user may rotate the rotating element on the wearable device and the progress indicator 606 will travel around the circle until it returns to its initial position at which point the selection will be confirmed. In some instances, there may be a countdown timer 604 indicating that user should confirm their selection within the time limit, or the transaction will be canceled. There is an optional cancel button 602 which the user may select at any time to cancel the selection. If the user rotates the rotating element completely the system will confirm the bet and the user interface 110 will transition to FIG. 7.

FIG. 7 depicts an exemplary user interface with a confirming notification for a wearable device, according to aspects described herein. In this instance, the user has confirmed their selection and a confirming message 702 may be displayed on the user interface 110. The confirming message 702 may include a receipt number which may be available in the user's account in data storage. A continue button 704 may be included to transition the user back to the main menu screen 202 in FIG. 2.

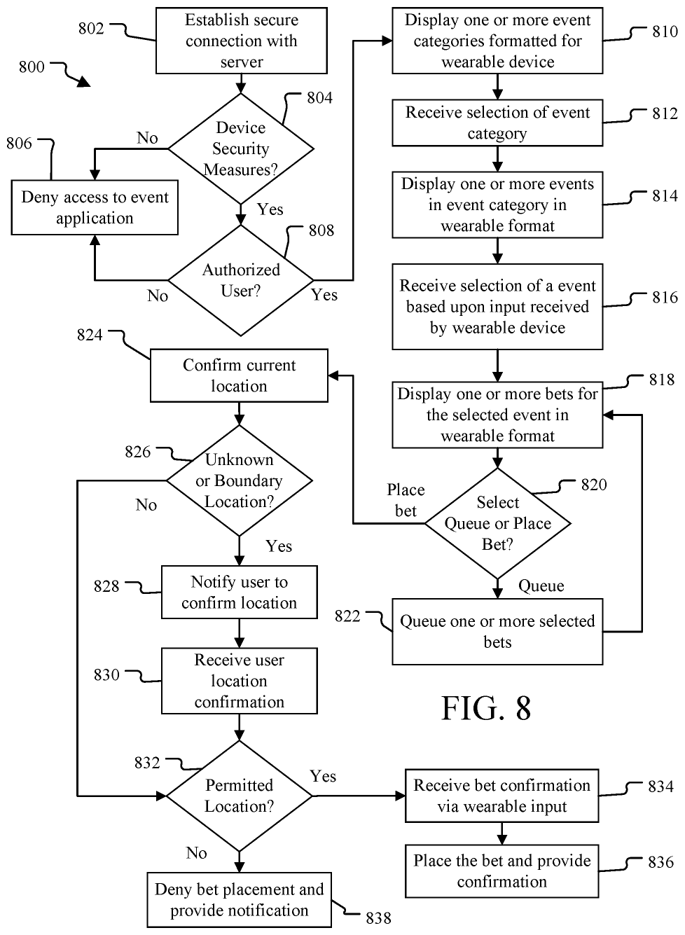

FIG. 8 is a block diagram illustrating a method for placing a bet via an event application on a wearable device, according to aspects described herein. Flow begins with operation 802, where a secure connection is established with the server. In examples, the secure connection may be established directly between a wearable device (e.g., wearable device 102) and the server (e.g., server 106). In such examples, the wearable device may be connected directly to the server via a network connection. The secure connection may be established using an encrypted or otherwise secure communications protocol, such as HTTPS. Alternatively, an intermediate device, such as a mobile device (e.g., mobile device 104) connected to the wearable device, may establish a secure connection with the server, again using a secure communication protocol such as HTTPS. When an intermediate device is used, a secure connection may already exist between the wearable device and the intermediate device or may be established prior to establishing the secure connection with the server.

Flow progresses to operation 804 where it is determined if device security measures are in place to place a bet via the wearable device (e.g., wearable device 102). In order to place a bet, the device that is connected to the server should have sufficient security measures active. The security measures may be one or more of a username and password combination, a pin specific to the user, and/or biometric security measures. The security engine (e.g., security engine 124) will verify that such measures are active or not. If the security measures are not active, flow progresses to operation 806 where the security engine will deny access to the event application (e.g., event application 120) until such security measures are activated.

Returning to operation 804, if the security measures are confirmed to be active, flow progresses to operation 808 where the security engine (e.g., security engine 102) authorizes the user via one or more of the security measures. In some examples, data stored by the wearable device (e.g., wearable device 102) or intermediate device (e.g., mobile device 104 or computing device 110), such as a cookie or a certificate, may be used to authenticate the user. If the user is not authorized by one of these security measures flow progresses to operation 806, where the security engine will deny access to the event application (e.g., event application 120) until the user may be authorized.

Alternatively, if the user is authorized flow progresses to operation 810, where one or more event categories formatted for the wearable device (e.g., wearable device 102) are displayed. In one aspect, the event categories may be received in a format compatible with the wearable device. That is, the server (e.g., server 106) may determine, based upon the type of the wearable device sending the request for the event categories, to provide the event categories based upon the wearable device's form factor. Alternatively, or additionally, the data may be formatted at the wearable device upon receipt by the wearable device manager (e.g., wearable device manager 122). In one example, the data may be formatted for display on a smartwatch, such as the user interface 110 depicted in FIG. 2. Alternatively, the data may be formatted for audio output, haptic feedback, or any other type of output format that the wearable device is capable of supporting. In examples, a category may be a sport, a league, an e-sport, a game type, a video game, or the like.

Flow continues to operation 812 where, after displaying the event categories, a selection of the category is received. For example, the wearable device (e.g., wearable device 102) may be operable to receive input via the interaction processor (e.g., interaction processor 128) to navigate through the received event categories. In one aspect, the navigation input may be a gesture, such as a swipe up, swipe down, swipe left, or swipe right, tap on a corner or edge of the wearable display, or the like. Alternatively, or additionally, the navigation input may be audio input (e.g., receipt of speech commands). In still further aspects, the navigation input may be received via a control associated with the wearable device. For example, rotation of the watch rotating element may cause the wearable user interface to scroll up or down, left, or right, to display additional categories or to cycle through categories. Selection of a specific event category may be determined based upon receipt of a selection input. A selection input may be a tap on a specific category, a long press or hold on a specific category, a speech selection (e.g., “Show me NBA games”), or received via a wearable device specific component (e.g., a press of a watch crown).

Upon receiving a selection of an event category, flow continues to operation 814, where a list of available events (e.g., in-progress or upcoming games) is displayed or otherwise provided on the wearable device (e.g., wearable device 102). In one aspect, upon receiving a selection of the event category, the wearable device may send a request for in-progress or upcoming games associated with the category to a server (e.g., server 106). In response, the server sends information about in-progress or upcoming games to the wearable device. As discussed above, the server may format the information based upon the type of wearable device sending the request. Alternatively, the wearable device may format the information upon receipt. As discussed above, the data may be formatted for display on a smartwatch, such as the display for smartwatch 110 depicted in FIG. 1. Alternatively, the data may be formatted for audio output, haptic feedback, or any other type of output format that the wearable device can support.

At operation 816, a selection of an available event is received. As discussed above, the selection operation may include receiving navigation input to navigate through the list of available devices. Similar input types as described above (e.g., gestures, speech commands, crown manipulations, etc.) may be used to navigate and select an event from the list of events.

In response to receiving the selection of the available event, betting opportunities for the available event are displayed at operation 818. For example, the wearable device (e.g., wearable device 102) performing the method 800 may send a request to the server for all bets available for the selected event. In response, the server (e.g., server 106) may provide information on betting opportunities (e.g., available bets, odds, payouts, etc.), to the wearable device over the network (e.g., network 150). As discussed above, the server may format the betting opportunity information based upon the form factor for the requesting wearable device prior to sending the betting opportunity information. Alternatively, the wearable device may format the betting opportunity data upon receipt of the information.

At operation 820, the user may provide gesture input and/or physical input the wearable device (e.g., wearable device 102) and the interaction processor (e.g., interaction processor 128) may determine if the user is requesting to queue or place the bet. In instances where the user is queueing the bet, flow progresses to operation 822 where the bet is queued in the user account in data storage (e.g., data storage 114) for a later time. In some instances, rather than immediately placing the bet the user may queue a bet in the user account for later placement. The later placement may occur as a result of a timer function associated with the queued bet or by manual placement by the user. In the case of the timer, there may be a feature enabling the use to select the date and time to place the bet and if selected the system will queue the bet until the appropriate time and then place the bet. Queueing may occur because the user wishes to consider the bet for placing it. Alternatively, it may occur because the current location of the wearable device (e.g., wearable device 102) or intermediate device (e.g., mobile device 104 and computing device 108) cannot be geo-located to meet certain regulatory requirements associated with placing a bet. The user may access their user profile to view queued bets and provide input to delete the queued bet or place the bet. In examples, the user may input a bet amount via gesture and/or physical input via the wearable device controls as part of the input for placing and/or queueing a bet.

Returning to operation 820, if the user requests to place the bet flow progresses to operation 824 where the system confirms the current location of the wearable device (e.g., wearable device 102) or intermediate device (e.g., mobile device 104 and computing device 106). Based on regulatory requirements related to betting, the current location of the device may need to be confirmed prior to placing a bet. The interaction processor (e.g., interaction processor 128) may determine the current location of the wearable device 102 by requesting the current location of the wearable device from a location enabled device. In examples where the wearable device itself is capable of performing location services, the wearable device will determine its current location and return it to the interaction processor. In examples where the wearable device utilizes an intermediate device to perform location services, the request will be processed by the applicable intermediate device.

At operation 826, it is determined if the current location is an unknown or boundary location. An unknown location is a situation where for some reason the current location is unable to be determined and/or provided to the interaction processor (e.g., interaction processor 128). This may occur due to location services being disabled on the wearable device (e.g., wearable device 102) and/or on the intermediate device (e.g., mobile device 104 and computing device 108), location services being unavailable due to a network connectivity issue, the wearable device being too distant from the intermediate device, and/or a variety of other reasons. A boundary location is a location that is close enough to a regulatory boundary that the interaction processor cannot determine if the current location is within the regulatory area that permits betting or if the current location is within the regulatory area that restricts betting. For example, a user could be traveling in a car using their wearable device, which may be close to a boundary location between two states where state A permits betting and state B restricts betting. Based on the movement of the car the current location may be classified a boundary location. Both the unknown location and boundary location determinations exist to ensure that the system does not place a bet from a location where betting is regulated and/or potentially restricted.

If the current location is an unknown and/or boundary location, flow progresses to operation 828 where a notification will be displayed to requesting the user confirm their location. The interaction processor (e.g., interaction processor 128) will request the user confirm their location. The request may include additional instructions and/or a link providing instructions for how to confirm the location and a separate interactive element for the user to select when the instructions have been followed. Confirming the location may involve moving the wearable device (e.g., wearable device 102) closer to the intermediate device (e.g., mobile device 104 and computing device 108) to ensure the current location when the bet is placed is within the permitted regulatory area, enabling location services on the wearable device and/or intermediate device, changing the position of the location enabled device and reattempting the location request, among other options. One or more of the options may be performed by the user, who may then select the interactive element to reattempt the location request. Flow progresses to operation 830, where it is determined if the location is confirmed by the user action. If the reattempt is successful, meaning the current location can be confirmed, flow progresses to operation 832.

Returning to operation 826, if the current location is known and not a boundary location and or the current location was confirmed at operation 830, flow progresses to operation 832 where the interaction processor (e.g., interaction processor 128) or the server (e.g., server 106) will determine if the current location is a permitted location. A permitted location is a location within a regulatory area that permits betting. If the current location is not a permitted location flow will progress to operation 838 where the interaction processor or server will deny the placement of the bet and inform the user that the current location is not a permitted location and the bet cannot be placed due to regulatory restrictions, and/or recommend alternative workflows (e.g., queueing the bet for later, offering alternative overlays, additional instructions to reattempt a location request, etc.).

Returning to operation 832, if the current location is a permitted location, the interaction processor (e.g., interaction processor 128) or server (e.g., server 106) will proceed to operation 834 the interaction processor or server will receive a bet confirmation via wearable input by a rotation of the rotational element of the wearable device. At operation 836, the interaction processor may request the server place the bet and provide confirmation of the placed bet with a receipt to the user on the wearable device (e.g., wearable device 102). Alternatively, the server may place the bet and provide confirmation notification. The steps of placing the bet may include deducting a monetary value from the user's account matching the bet amount placed by the user.

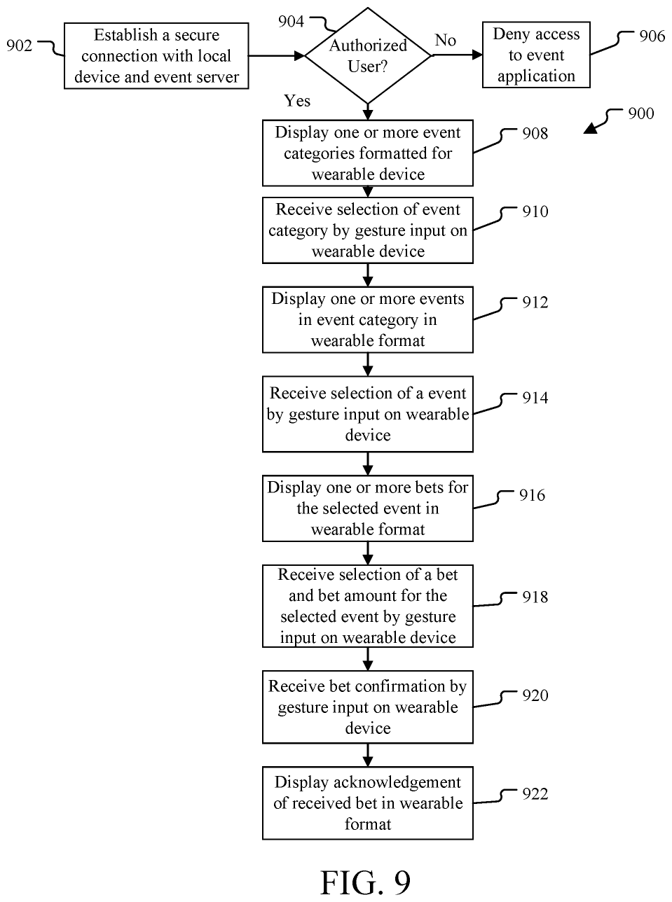

FIG. 9 is a block diagram illustrating a method for placing a bet from a wearable device, according to aspects described herein. Flow begins with operation 902, where a secure connection is established with the server. In examples, the secure connection may be established directly between a wearable device (e.g., wearable device 102) and the server (e.g., server 106). In such examples, the wearable device may be connected directly to the server via a network connection. The secure connection may be established using an encrypted or otherwise secure communications protocol, such as HTTPS. Alternatively, an intermediate device, such as a mobile device (e.g., mobile device 104) connected to the wearable device, may establish a secure connection with the server, again using a secure communication protocol such as HTTPS. When an intermediate device is used, a secure connection may already exist between the wearable device and the intermediate device or may be established prior to establishing the secure connection with the server.

Flow progresses to operation 904 where it is determined if the user is authorized via one or more of the security measures on the wearable device (e.g., wearable device 102). In examples, the security engine (e.g., security engine 102) may authorize the user via one or more of the security measures such as a username and password combination, pin code, and/or biometric security features. In some examples, data stored by the wearable device (e.g., wearable device 102) or intermediate device (e.g., mobile device 104 or computing device 110), such as a cookie or a certificate, may be used to authenticate the user. If the user is not authorized by one of these security measures flow progresses to operation 906, where the security engine will deny access to the event application (e.g., event application 120) until the user may be authorized.

Alternatively, if the user is authorized flow progresses to operation 908, where one or more event categories formatted for the wearable device (e.g., wearable device 102) are displayed. In one aspect, the event categories may be received in a format compatible with the wearable device. That is, the server (e.g., server 106) may determine, based upon the type of the wearable device sending the request for the event categories, to provide the event categories based upon the wearable device's form factor. Alternatively, or additionally, the data may be formatted at the wearable device upon receipt by the wearable device manager (e.g., wearable device manager 122). In one example, the data may be formatted for display on a smartwatch, such as the user interface 110 depicted in FIG. 2. Alternatively, the data may be formatted for audio output, haptic feedback, or any other type of output format that the wearable device is capable of supporting. In examples, a category may be a sport, a league, an e-sport, a game type, a video game, or the like.

Flow continues to operation 910 where, after displaying the event categories, a selection of the category is received. For example, the wearable device (e.g., wearable device 102) may be operable to receive input via the interaction processor (e.g., interaction processor 128) to navigate through the received event categories. In one aspect, the navigation input may be a gesture, such as a swipe up, swipe down, swipe left, or swipe right, tap on a corner or edge of the wearable display, or the like. Alternatively, or additionally, the navigation input may be audio input (e.g., receipt of speech commands). In still further aspects, the navigation input may be received via a control associated with the wearable device. For example, rotation of the watch rotating element may cause the wearable user interface to scroll up or down, left, or right, to display additional categories or to cycle through categories. Selection of a specific event category may be determined based upon receipt of a selection input. A selection input may be a tap on a specific category, a long press or hold on a specific category, a speech selection (e.g., “Show me NBA games”), or received via a wearable device specific component (e.g., a press of a watch crown).

Upon receiving a selection of an event category, flow continues to operation 912, where a list of available events (e.g., in-progress or upcoming games) is displayed or otherwise provided on the wearable device (e.g., wearable device 102). In one aspect, upon receiving a selection of the event category, the wearable device may send a request for in-progress or upcoming games associated with the category to a server (e.g., server 106). In response, the server sends information about in-progress or upcoming games to the wearable device. As discussed above, the server may format the information based upon the type of wearable device sending the request. Alternatively, the wearable device may format the information upon receipt. As discussed above, the data may be formatted for display on a smartwatch, such as the display for smartwatch 110 depicted in FIG. 1. Alternatively, the data may be formatted for audio output, haptic feedback, or any other type of output format that the wearable device can support.

At operation 914, a selection of an available event is received. As discussed above, the selection operation may include receiving navigation input to navigate through the list of available devices. Similar input types as described above (e.g., gestures, speech commands, crown manipulations, etc.) may be used to navigate and select an event from the list of events.

In response to receiving the selection of the available event, betting opportunities for the available event are displayed at operation 916. For example, the wearable device (e.g., wearable device 102) performing the method 800 may send a request to the server for all bets available for the selected event. In response, the server (e.g., server 106) may provide information on betting opportunities (e.g., available bets, odds, payouts, etc.), to the wearable device over the network (e.g., network 150). As discussed above, the server may format the betting opportunity information based upon the form factor for the requesting wearable device prior to sending the betting opportunity information. Alternatively, the wearable device may format the betting opportunity data upon receipt of the information.

At operation 918, the user may provide gesture input and/or physical input on a physical device and the interaction processor (e.g., interaction processor 128) requesting to place the bet and providing a bet amount. In examples, the user may input a bet amount via gesture and/or physical input via the wearable device controls. Depending upon the form factor of the wearable device, the bet amount may be received via an interaction with a touch screen, a speech command, a gesture input, or the like. In one example, when the wearable device is a smartwatch, the bet amount may be adjusted using the watch crown (e.g., turning clockwise increases the betting amount while turning counterclockwise decreases the amount). Alternatively, or additionally, the betting amount may be received via gesture input, such as swiping or scrolling up to increase the amount and swiping or scrolling down to decrease the amount, using a circular motion gesture to increase or decrease the amount based upon direction, or the like. In examples, the bet may be received by either adjusting a wager field or a win field, as described with respect to FIG. 5. As such, the user has the opportunity to determine a betting amount based upon how much they want to wager or how much they hope to win. In some examples, the user may place a previously queued bet by accessing the queued bet via the user account in data storage (e.g., data storage 114). The user may select the bet from a set of previously queued bets and submit it via gesture input to the interaction processor for placement.

At operation 920, the wearable device (e.g., wearable device 102) may receive confirmation via gesture input or physical input from the user. Once the desired bet amount is received, the betting amount can be locked in by tapping on the smartwatch touch screen, pressing the crown, etc. In order to ensure that a betting amount is not accidentally entered, an additional step may be required to confirm the bet. For example, upon receiving a final bet amount, the wearable device may prompt the user to perform a specific gesture, or to turn the crown in a specific direction, in order to confirm that the user intends to place the received bet amount. For example, if the confirmation requires spinning the crown of a smartwatch, the smartwatch may display a progress indicator (e.g., progress indicator 606), as shown in FIG. 6. Upon receiving the corresponding input, the selected bet and the betting amount may be sent to the server to finalize the bet. In response, a confirmation acknowledgment may be received from the server and displayed to the user at operation 922.

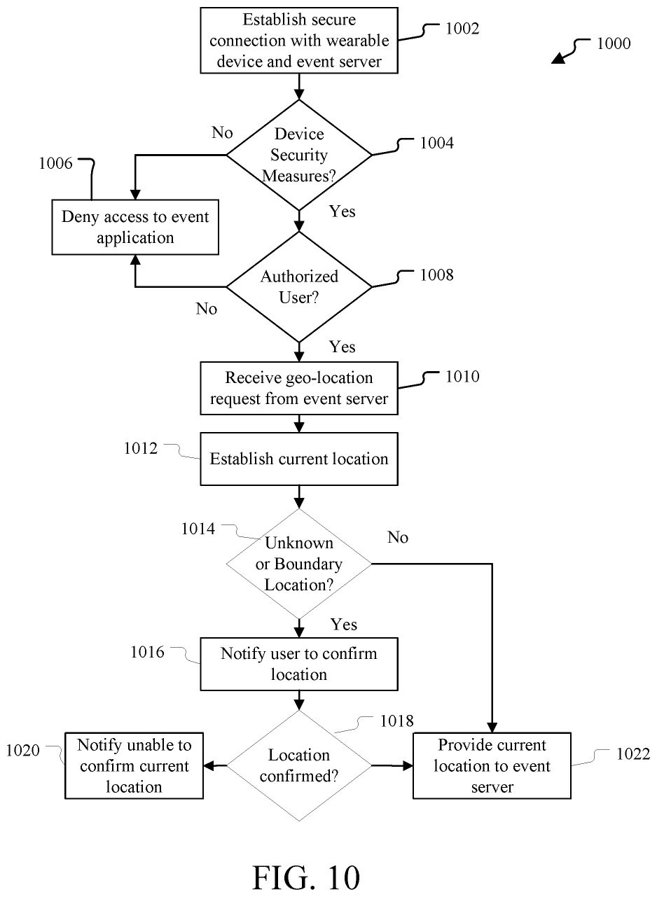

FIG. 10 is a block diagram illustrating a method for authorizing a user and geo-locating a device by an intermediate device, according to aspects described herein. Flow begins with operation 1002, where a secure connection is established between the intermediate device (e.g., mobile device 104 and/or computing device 108), wearable device (e.g., wearable device 102), and the server (e.g., server 106). The secure connection may be established using an encrypted or otherwise secure communications protocol, such as HTTP S.

Flow progresses to operation 1004 where it is determined if intermediate device (e.g., mobile device 104 and/or computing device 108) security measures are in place to place a bet via the wearable device (e.g., wearable device 102). In order to place a bet, the intermediate device that is connected to the server should have sufficient security measures active. The security measures may be one or more of a username and password combination, a pin specific to the user, and/or biometric security measures. The security engine (e.g., security engine 124) will verify that such measures are active or not. If the security measures are not active, flow progresses to operation 1006 where the security engine will deny access to the event application (e.g., event application 120) until such security measures are activated.

Returning to operation 1004, if the security measures are confirmed to be active, flow progresses to operation 1008 where the security engine (e.g., security engine 102) authorizes the user via one or more of the security measures. In some examples, data stored by the wearable device (e.g., wearable device 102) or intermediate device (e.g., mobile device 104 or computing device 110), such as a cookie or a certificate, may be used to authenticate the user. If the user is not authorized by one of these security measures flow progresses to operation 1006, where the security engine will deny access to the event application (e.g., event application 120) until the user may be authorized.

If the user is authorized, flow progresses to operation 1010, where a geo-location request from the event server is received by the intermediate device (e.g., mobile device 104 and/or computing device 108). The request may be received from the interaction processor (e.g., interaction processor 128). At operation 1012, the intermediate device may utilize geolocation services to determine its current location.

At operation 1014, it is determined if the current location is an unknown or boundary location. An unknown location is a situation where for some reason the current location is unable to be determined and/or provided to the interaction processor (e.g., interaction processor 128). This may occur due to location services being disabled on the intermediate device (e.g., mobile device 104 and computing device 108), location services being unavailable due to a network connectivity issue, the wearable device being too distant from the intermediate device, and/or a variety of other reasons. A boundary location is a location that is close enough to a regulatory boundary that the interaction processor cannot determine if the current location is within the regulatory area that permits betting or if the current location is within the regulatory area that restricts betting. Both the unknown location and boundary location determinations exist to ensure that the system does not place a bet from a location where betting is regulated and/or potentially restricted.

If the current location is an unknown and/or boundary location, flow progresses to operation 1016 where a notification will be displayed to requesting the user confirm their location. The interaction processor (e.g., interaction processor 128) will request the user confirm their location. The request may include additional instructions and/or a link providing instructions for how to confirm the location and a separate interactive element for the user to select when the instructions have been followed. Confirming the location may involve moving the wearable device (e.g., wearable device 102) closer to the intermediate device (e.g., mobile device 104 and computing device 108) to ensure the current location when the bet is placed is within the permitted regulatory area, enabling location services on the intermediate device, changing the position of the location enabled device and reattempting the location request, among other options. One or more of the options may be performed by the user, who may then select the interactive element to reattempt the location request. Flow progresses to operation 1018, where it is determined if the location is confirmed by the user action. If the reattempt is successful, meaning the current location can be confirmed, flow progresses to operation 1022, where the current location is provided to the server (e.g., server 106). If the location cannot be confirmed at operation 1018, then flow progresses to operation 1020, where a notification is provided that the current location cannot be confirmed, and the bet cannot be placed.

Returning to operation 1014, if the current location is known and not a boundary location, flow progresses to operation 1022 where the current location is provided to the server (e.g., server 106).

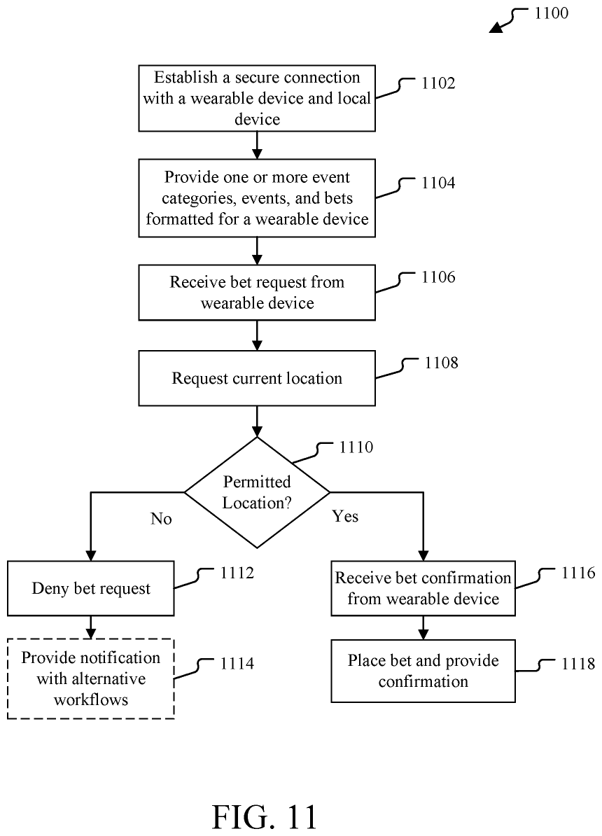

FIG. 11 is a block diagram illustrating a method for receiving a bet at an event server, according to aspects described herein. Flow begins with operation 1102, where a secure connection is established between the intermediate device (e.g., mobile device 104 and/or computing device 108), wearable device (e.g., wearable device 102), and the server (e.g., server 106). The secure connection may be established using an encrypted or otherwise secure communications protocol, such as HTTPS.

At operation 1104, the server (e.g., server 106) provides one or more event categories, events, and/or bets formatted for a wearable device (e.g., wearable device 102). Based on the requests from the wearable device the server may transmit the requested information formatted for the wearable device. At operation 1104, the server may receive a bet request from the wearable device. The bet request may include a bet amount and an indication of if the bet should be placed immediately or queued for later access via the user account. When placing a bet, flow progresses to operation 1108 where the server will request the current location from the interaction processor (e.g., interaction processor 128). A location enabled device utilized in the present configuration will complete the request, if able, and return the current location to the server.

At operation 1110, the server will determine if the current location is a permitted location or not. The server (e.g., server 106) will determine if the current location is a permitted location. A permitted location is a location within a regulatory area that permits betting. If the current location is not a permitted location flow will progress to operation 1112 where the server will deny the placement of the bet and inform the user that the current location is not a permitted location and the bet cannot be placed. Optionally, at operation 1114, the server may provide notification with recommended alternative workflows (e.g., queueing the bet for later, offering alternative overlays, additional instructions to reattempt a location request, etc.) to place the bet at a later time.

Returning to operation 1110, if the current location is a permitted location, flow proceeds to operation 1116, where the server (e.g., server 106) will receive a bet confirmation via gesture input and/or physical input by a rotation of the rotational element of the wearable device. At operation 1118, the interaction processor may place the bet and provide confirmation of the placed bet with a receipt to the user on the wearable device (e.g., wearable device 102). The steps of placing the bet may include deducting a monetary value from the user's account matching the bet amount placed by the user.

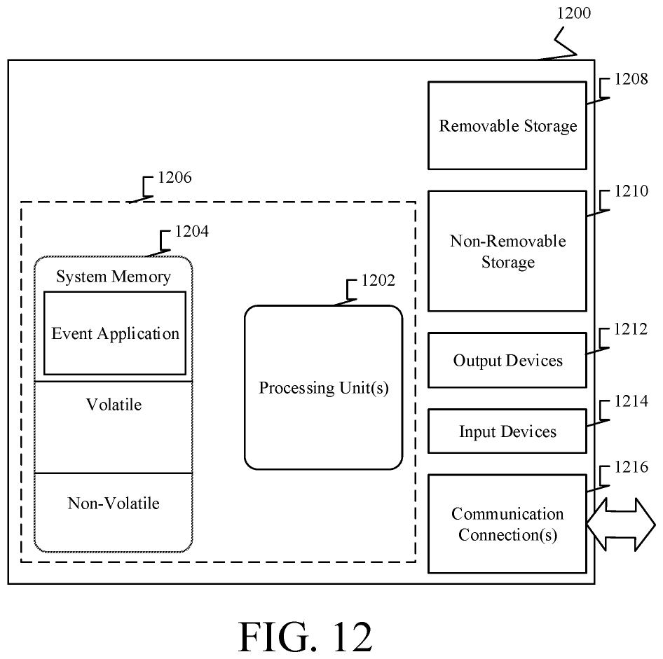

FIG. 12 illustrates a simplified block diagram of a device with which aspects of the present disclosure may be practiced, according to aspects described herein. The device may be a mobile computing device or a VR device for example. One or more of the present embodiments may be implemented in an operating environment 1200. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smartphones, network PCs, minicomputers, mainframe computers, distributed computing environments that include any of the above systems or devices, and the like.

In its most basic configuration, the operating environment 1200 typically includes at least one processing unit 1202 and memory 1204. Depending on the exact configuration and type of computing device, memory 1204 (instructions to perform for performing the aspects disclosed herein) may be volatile (such as RAM), non-volatile (such as ROM, flash memory, etc.), or some combination of the two. This most basic configuration is illustrated in FIG. 12 by dashed line 1206. Further, the operating environment 1200 may also include storage devices (removable, 1208, and/or non-removable, 1210) including, but not limited to, magnetic or optical disks or tape. Similarly, the operating environment 1200 may also have input device(s) 1214 such as remote controller, keyboard, mouse, pen, voice input, on-board sensors, etc. and/or output device(s) 1212 such as a display, speakers, printer, motors, etc. Also included in the environment may be one or more communication connections, 1216, such as LAN, WAN, a near-field communications network, a cellular broadband network, point to point, etc.

Operating environment 1200 typically includes at least some form of computer readable media. Computer readable media can be any available media that can be accessed by the at least one processing unit 1202 or other devices comprising the operating environment. By way of example, and not limitation, computer readable media may comprise computer storage media and communication media. Computer storage media includes volatile and nonvolatile, removable, and non-removable media implemented in any method or technology for storage of information such as computer readable instructions, data structures, program modules or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, non-transitory medium which can be used to store the desired information. Computer storage media does not include communication media. Computer storage media does not include a carrier wave or other propagated or modulated data signal.

Communication media embodies computer readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

The operating environment 1200 may be a single computer operating in a networked environment using logical connections to one or more remote computers. The remote computer may be a personal computer, a server, a router, a network PC, a peer device, or other common network node, and typically includes many or all of the elements described above as well as others not so mentioned. The logical connections may include any method supported by available communications media. Such networking environments are commonplace in offices, enterprise-wide computer networks, intranets, and the Internet.

According to an embodiment of the present disclosure, a system is disclosed comprising, a server, an intermediate device, a wearable device at least one processor, and memory storing instructions that, when executed by the at least one processor, cause the system to perform a set of operations, the set of operations comprising establish a secure connection between the wearable device having an event application and the intermediate device, establish a secure connection between the intermediate device and the event server authorize the user via one or more security measures when the user is authorized, display one or more event categories formatted for the wearable device, receive a selection of an event category via gesture input, display one or more events based on the selected event category in a wearable format, receive a selection of an event via gesture input, display one or more bets based on the selected event in a wearable format, receive a selection of a bet and a bet amount for the selected event via gesture input, receive bet confirmation via gesture input on wearable device, and display an acknowledgement of the received bet.

In various embodiments of the disclosure, the wearable device comprises a smartwatch.

In various embodiments of the disclosure, the intermediate device further comprising one of a mobile phone, tablet, and computing device.

In various embodiments of the disclosure, the security measures comprise one or more of a username and password combination, a PIN code, fingerprint recognition, facial recognition, and other biometric security measures.

In various embodiments of the disclosure, further comprising when the user is not authorized, deny access the event application.

In various embodiments of the disclosure, a gesture input is one or more of a horizontal swipe, vertical swipe, touch input, and rotational input on a rotation element of the wearable device.

In various embodiments of the disclosure, a permitted location comprises an area where the event application is permitted to operate under the relevant event regulations for the area.

According to an embodiment of the present disclosure, a system is disclosed comprising a server, an intermediate device, a wearable device, at least one processor, and memory storing instructions that, when executed by the at least one processor, cause the system to perform a set of operations, the set of operations comprising establish a secure connection between the wearable device having an event application and the intermediate device, establish a secure connection between the intermediate device and the event server, determine if the intermediate device has one or more security measures enabled, when the intermediate device has one or more security measures enabled, authorize the user via the one or more security measures, when the user is authorized, receive a geo-location request from the event server. determine a current location of the intermediate device and provide the current location of the intermediate device to the event server.

In various embodiments of the disclosure, further comprising when the intermediate device does not have one or more security measures enabled, deny access to the event application.

In various embodiments of the disclosure, further comprising when the user is not authorized, deny access to the event application.

In various embodiments of the disclosure, the wearable device comprises a smartwatch.

In various embodiments of the disclosure, wherein the security measures comprise one or more of a username and password combination, a PIN code, fingerprint recognition, facial recognition, and other biometric security measures.

In various embodiments of the disclosure, further comprising when the current location is an unknown or a boundary location, notify the user to confirm the current location on the geolocation-enabled device, and when the current location is confirmed, provide the current location of the intermediate device to the event server.

In various embodiments of the disclosure, further comprising when the current location is not concerned, notify the event server that the current location is not confirmed.

In various embodiments of the disclosure, wherein the intermediate device further comprising one of a mobile phone, tablet, and computing device.

According to an embodiment of the present disclosure, a system is disclosed comprising a server, an intermediate device, a wearable device, at least one processor, and memory storing instructions that, when executed by the at least one processor, cause the system to perform a set of operations, the set of operations comprising establish a secure connection between the wearable device having an event application and the intermediate device, establish a secure connection between the intermediate device and the event server, provide one or more event categories, events, and bets formatted for a wearable device, receive a bet request from a wearable device, request a current location from the intermediate device, determine if the current location is a permitted location, when the current location is a permitted location, receive bet confirmation from the wearable device, and place the bet and provide bet confirmation acknowledgement to the wearable device.

In various embodiments of the disclosure, further comprising when the current location is not a permitted location, deny the bet request.

In various embodiments of the disclosure, further comprising provide notification to move to permitted location to place bet.

In various embodiments of the disclosure, wherein the wearable device comprises a smartwatch.

In various embodiments of the disclosure, wherein the intermediate device further comprising one of a mobile phone, tablet, and computing device.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The methods and order of operations for a method disclosed herein are exemplary, such that the steps of the method may be reorganized, added to, combined, and/or steps may be omitted as is contemplated by one having skill in the art. The claimed disclosure should not be construed as being limited to any aspect, for example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A system comprising:
a server;
an intermediate device;
a wearable device;
at least one processor; and
memory storing instructions that, when executed by the at least one processor, cause the system to perform a set of operations, the set of operations comprising:
establish a secure connection between the wearable device having an event application and the intermediate device;
establish a secure connection between the intermediate device and the event server;
authorize the user via one or more security measures;
when the user is authorized, display one or more event categories formatted for the wearable device;
receive a selection of an event category via gesture input;
display one or more events based on the selected event category in a wearable format;
receive a selection of an event via gesture input;
display one or more bets based on the selected event in a wearable format;
receive a selection of a bet and a bet amount for the selected event via gesture input;
receive bet confirmation via gesture input on wearable device; and
display an acknowledgement of the received bet.

2. The system of claim 1, wherein the wearable device comprises a smartwatch.

3. The system of claim 1, wherein the intermediate device further comprising one of a mobile phone, tablet, and computing device.

4. The system of claim 1, wherein the security measures comprise one or more of a username and password combination, a PIN code, fingerprint recognition, facial recognition, and other biometric security measures.

5. The system of claim 1, further comprising:
when the user is not authorized, deny access the event application.

6. The system of claim 1, wherein a gesture input is one or more of a horizontal swipe, vertical swipe, touch input, and rotational input on a rotation element of the wearable device.

7. The system of claim 1, wherein a permitted location comprises an area where the event application is permitted to operate under the relevant event regulations for the area.

8. A system comprising:
a server;
an intermediate device;
a wearable device;
at least one processor; and
memory storing instructions that, when executed by the at least one processor, cause the system to perform a set of operations, the set of operations comprising:
establish a secure connection between the wearable device having an event application and the intermediate device;
establish a secure connection between the intermediate device and the event server;
determine if the intermediate device has one or more security measures enabled;
when the intermediate device has one or more security measures enabled, authorize the user via the one or more security measures;
when the user is authorized, receive a geo-location request from the event server;
determine a current location of the intermediate device; and
provide the current location of the intermediate device to the event server.

9. The system of claim 8, further comprising:
when the intermediate device does not have one or more security measures enabled, deny access to the event application.

10. The system of claim 8, further comprising:
when the user is not authorized, deny access to the event application.

11. The system of claim 8, wherein the wearable device comprises a smartwatch.

12. The system of claim 8, wherein the security measures comprise one or more of a username and password combination, a PIN code, fingerprint recognition, facial recognition, and other biometric security measures.

13. The system of claim 8, further comprising:
when the current location is an unknown or a boundary location, notify the user to confirm the current location on the geolocation-enabled device; and
when the current location is confirmed, provide the current location of the intermediate device to the event server.

14. The system of claim 13, further comprising:
when the current location is not concerned, notify the event server that the current location is not confirmed.

15. The system of claim 8, wherein the intermediate device further comprising one of a mobile phone, tablet, and computing device.

16. A system comprising:
a server;
an intermediate device;
a wearable device;
at least one processor; and
memory storing instructions that, when executed by the at least one processor, cause the system to perform a set of operations, the set of operations comprising:
establish a secure connection between the wearable device having an event application and the intermediate device;
establish a secure connection between the intermediate device and the event server;
provide one or more event categories, events, and bets formatted for a wearable device;
receive a bet request from a wearable device;
request a current location from the intermediate device;
determine if the current location is a permitted location;
when the current location is a permitted location, receive bet confirmation from the wearable device; and
place the bet and provide bet confirmation acknowledgement to the wearable device.

17. The system of claim 16, further comprising:
when the current location is not a permitted location, deny the bet request.

18. The system of claim 16, further comprising:
provide notification to move to permitted location to place bet.

19. The system of claim 16, wherein the wearable device comprises a smartwatch.

20. The system of claim 16, wherein the intermediate device further comprising one of a mobile phone, tablet, and computing device.
